(19) United States
(12) Patent Application Publication
(10) Pub. No.: US 2007/0084350 A1
(43) Pub. Date: Apr. 19, 2007

(54) Self-cleaning and sterilizing apparatus for the concentrated purification of air

(76) Inventors: Nick Charles Parker, Lubbock, TX (US); Robert David Rogers, Lubbock, TX (US)

Correspondence Address: Dr. Nick Parker, 7805 Zoar Ave., Lubbock, TX, 79424, US

(21) Appl. No.: 11/249,209

(22) Filed: Oct. 13, 2005

(51) Int. Cl. B01D 46/00

(52) U.S. Cl. 96/224

(57) ABSTRACT

An apparatus for the filtration and decontamination of air flowing through an air stream through which a mechanical filter media is continually decontaminated and sterilized as it continues to remove airborne contaminants in said air stream. The air and airborne contaminants are subjected to high frequency ultraviolet light, destroying organic airborne materials. Said ultraviolet light will react with a surface coating of a photo-catalytic substance within the apparatus to create hydroxyl-radicals to bond with, and destroy organic airborne contaminants. Additionally, the configuration of said apparatus is effective in the removal and destruction of smoke and organic gases.

### BACKGROUND OF THE INVENTION

1. Field of the Invention

The present invention relates generally to a self-contained portable air purification system, and more specifically, to such a system which is capable of removing particulate matter, bacterial and viral contaminants and will prevent the gathering of mold and production of mycotoxins on the filter media, generally purifying the air within a contained environment.

2. Description of the Prior Art

A wide variety of air filter systems are presently available for use. These systems typically include a fan arrangement for circulating air, and a filter stage or a plurality of filter stages within the air path as to filter or purify the air that flows through them. There are many types of filters and filtration media, each with it's share of benefits and weaknesses. As can be expected with these existing systems, there are many variables that affect their efficiency and effectiveness.

The most basic form of air purification has been the means to mechanically separate the airborne contaminants from the air. This has been accomplished in the past through the use of specialized filters. In this method, a porous media is introduced into an existing air stream. As the air is allowed to pass through the layer or layers of media, airborne particles too large to navigate through the media are caught by the media filter.

There have been several advances made in air filtration in the previous years. These advances have been used alone and in tandem with existing air filters to provide a somewhat improved result. One such example is the existing electrostatic precipitator element which charges dust and airborne contaminants and attracts them to an electrically charged grid or plate.

Though these systems have provided for a higher quality and standard of air purification, they alone are not sufficient. Although it is generally known that adding more layers of filter media can continue improving air quality, it is essential to create a process in which the air is cleaned before, and after, introduction to the media.

Furthermore, in the event of mechanical filtration, it is sometimes common for the media face to become covered in contaminants. Although media manufacturers recommend periodic replacing of the filter media, it is not always possible or convenient.

One of the most serious concerns unanswered by standard mechanical or electrostatic air filtration is the threat of mold colonies. As mold is carried through an air stream and introduced to a mechanical filter, it will become trapped by means of the filter media. Through time, the accumulated mold spores may coalesce into a mold colony, through which spores are released into the air. As the mold colonies reach the end of their lifespan, they decay and release mycotoxins into the air. As such, the filtration media can become a virtual breeding ground for mycotoxins.

It is then necessary to create a product capable of enhancing the capabilities of the filter media while also enhancing the life of the media and without restricting airflow. In return, this improvement would result in an enhanced airflow and improve the overall quality of the air. What is needed is a method for purifying the air in an air stream as well as a means of continual decontamination of a media filter. This would be accomplished through the process of photo-catalysis, a well-known and documented means of decontamination utilizing ultraviolet radiation and a reactive catalyst.

### BRIEF DESCRIPTION OF THE ILLUSTRATIONS

The invention may take a variety of physical forms in parts or in an arrangement of parts, or in the preferred embodiments which will be described in detail in this specification and illustrated in the accompanying drawings which form a part hereof and wherein:

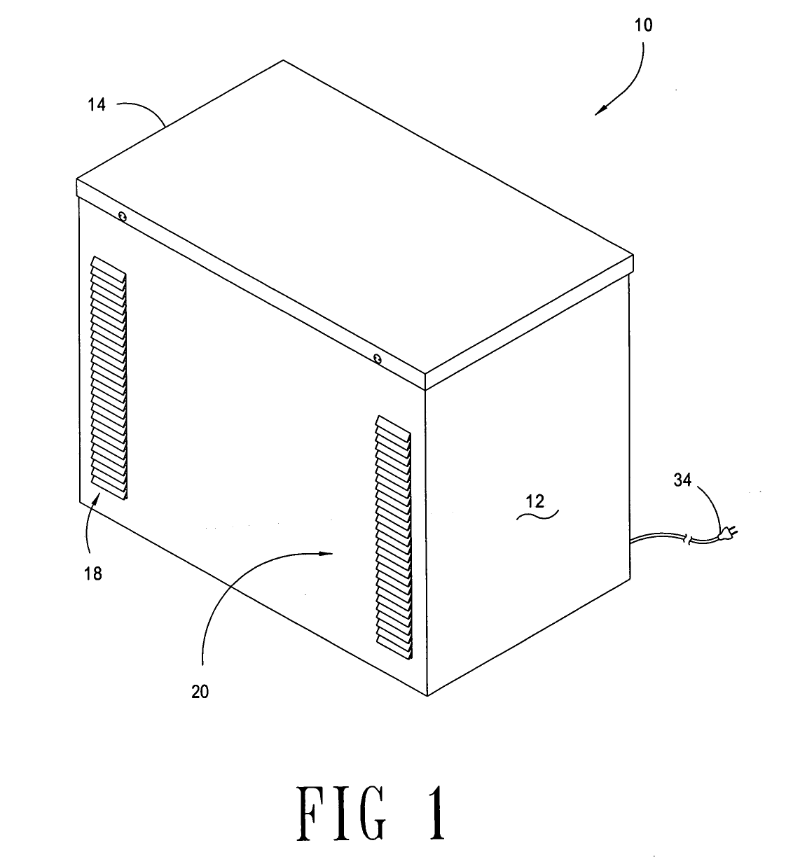

FIG. 1 is a perspective view of the invention in a closed state illustrating a single means for air entry and a single means for the exhausting of purified air.

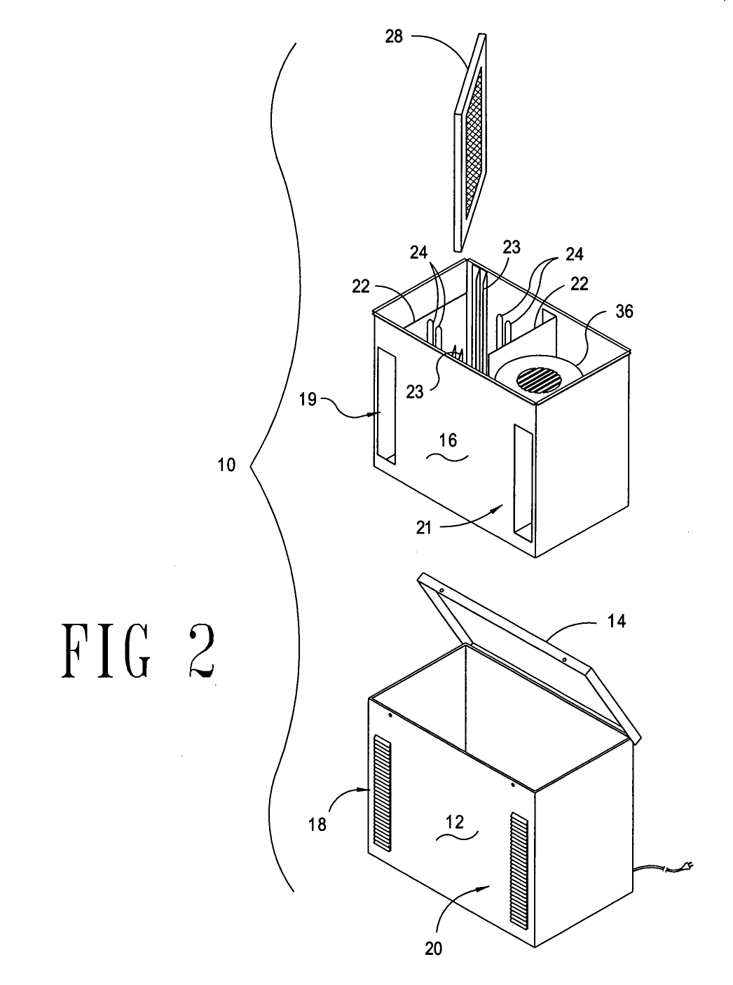

FIG. 2 is an exploded perspective view of the invention illustrating the components of the invention in relation to one another in the invention.

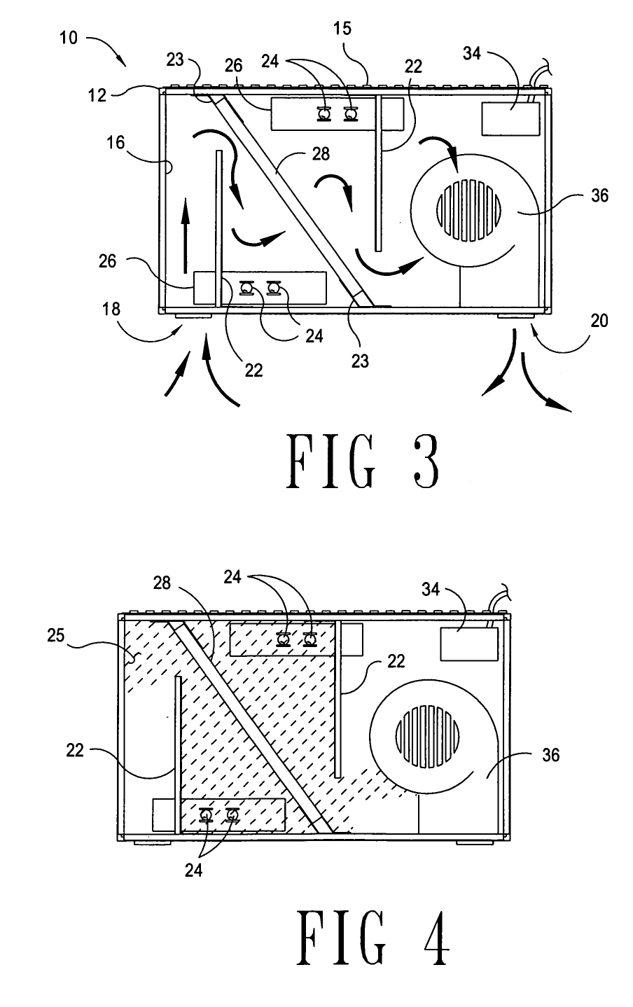

FIG. 3 is a top perspective view with portions removed illustrating the flow of air through the invention and once more focusing attention to a single entrance for contaminated air and a single means of exhausting purified air.

FIG. 4 is a top perspective view with portion removed illustrating the portion of the invention affected by direct contact to high frequency ultraviolet radiation. Additionally this view illustrates the exposure to ultraviolet radiation received by the filtration media.

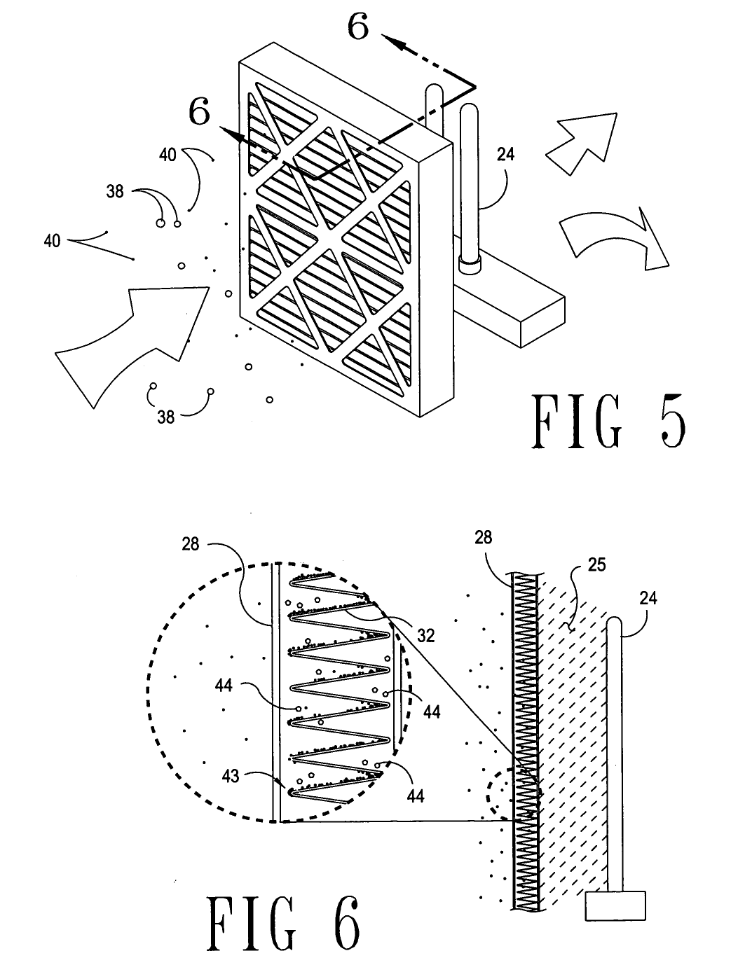

FIG. 5 is a perspective view of the prior art with portions removed illustrating how a mechanical filtration system removes contaminants from air stream before the air is subjected to ultraviolet radiation.

FIG. 6 is a side elevation taken about line 6-6 in FIG. 5 with portions removed illustrating the accumulation of mold and mycotoxins on a media surface not subjected to ultraviolet radiation.

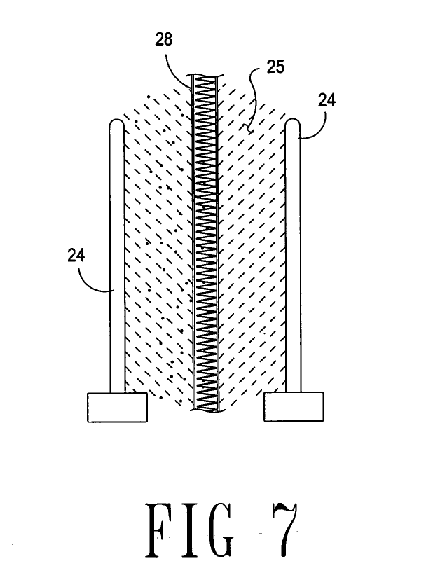

FIG. 7 is a side elevation with portions removed of the invention, illustrating the sterilizing effect of a plurality of ultraviolet lamps focused on a mechanical filtration media.

### DETAILED DESCRIPTION OF THE PREFERRED EMBODIMENT

Referring now to the drawings, wherein, the illustrations are for the purposes of illustrating the preferred embodiments of this invention only and not for the purposes of limiting same, FIG. 1 illustrates an innovative apparatus for the filtration and purification of air through the use of a self-contained air treatment apparatus generally indicated at 10.Said apparatus, having a lid, 14, is clearly shown to be self enclosed within a sealed casing, indicated at 12, and having a singular entry for the introduction of contaminated air, generally indicated at 18, and a singular exit for the exhaust of purified air, generally indicated at 20. The apparatus is powered by an external power source, through a standard power cord, 34.

Referring now to FIG. 2, the innovative apparatus for the filtration and purification of air is shown in an exploded view indicated by brackets as 10. The invention is comprised of and external housing structure, indicated at 12 which may be sealed with a lid, 14. A secondary structure, indicated at 16, is illustrated as having a means for containing a mechanical filtration media indicated at 28, a means for the circulation and exhausting of air indicated at 36, means for the directing of air flow indicated at 22, a plurality of ultraviolet lamps indicated at 24, a singular entry for the introduction of contaminated air generally indicated at 19, and a singular exit for the exhausting of purified air generally indicated at 21.

Referring now to FIG. 3, the innovative apparatus for the filtration and purification of air generally indicated at 10 is shown from a top perspective and illustrates the path of air as it flows within a secondary structure indicated at 16, through a means for the mechanical filtration of the air indicated at 28 and through the means for air circulation indicated at 36. It is evident in said illustration that the invention includes a means for the use of a mechanical lid, indicated at 15. An internal power regulator indicated at 34 distributes power to the air circulator 36 and a plurality of ultraviolet lamps indicated at 24.

With reference now to FIG. 4, the innovative apparatus for the filtration and purification of air is shown with a plurality of dashed lines labeled 25, indicating the areas of the secondary structure indicated at 16 that are exposed to ultraviolet radiation produced by the ultraviolet lamps indicated at 24. The areas exposed to said radiation are specifically designed to offer maximum exposure to introduced air by means of a series of air baffles indicated at 22 to cause turbulence and to maximize exposure time.

Referring now to FIG. 5, the prior art is often comprised of a filtration media placed in an existing air stream. As the air flows through, as indicated by the arrows, loose particulate matter indicated at 38 and mold spores indicated at 40 are carried along. As the filter media captures said airborne contaminants the air is allowed to pass into an immediate secondary phase of disinfection by a sterilizing ultraviolet lamp.

Regarding FIG. 6 now, the ineffectiveness of the prior art is visible. Even as a filtration media indicated at 28 captures mold spores, only one half of the filter media is exposed to the sterilization wavelength indicated at 25 produced by the sterilizing lamp, 24. As there would be a single sterile side of said media indicated at 32, the mold spores may accumulate on the non-sterile half of said media, and in time coalesce into mold colonies generally indicated at 43. As said mold colonies, 43, perish and decay over time, the colonies release harmful mycotoxins indicated at 44 into the air stream.

Now referring to FIG. 7, the innovative apparatus for the filtration and purification of air is shown; whereas, a mechanical means for the filtration of air indicated at 28 is exposed to a plurality of ultraviolet lamps indicated at 24. Said lamps produce an ultraviolet wavelength capable of destroying molds and organic contaminants. The result of the invention would be a mechanical and photo-reactive filtration media that is consistently sterilized on either side while providing clean and purified air.

The invention has been described with reference to preferred embodiments. It is obvious that alterations to the design and composition of materials may be adapted according to individual tastes or needs. It is intended to include all such modifications and alteration insofar as they come within the scope of the claims or the equivalents thereof.

What is claimed is:

1. An innovative apparatus for the filtration and purification of air comprising;
a self-contained interior structure designed for the purification of air comprising;
a case containing three or more sides;
a case formed from metal;
a means for the controlled maneuvering of air within said case;
a chamber designed to expose air and airborne contaminants to a quantity of ultraviolet radiation;
a means for the mechanical filtration of air within said case;
a means for generating ultraviolet radiation through a plurality of ultraviolet germicidal irradiation lamps;
a powered means for the introduction of contaminated air from an environment outside said case, and;
a powered means for the gathering and exhausting of purified air to the environment outside said case.

2. The apparatus of claim 1, wherein the means for mechanical air filtration is exposed to said ultraviolet radiation on two sides.

3. The apparatus of claim 1, wherein the ultraviolet germicidal irradiation lamps are placed as to illuminate all exposed surfaces on said mechanical filtration media.

4. The apparatus of claim 1, wherein the means for mechanical air filtration is exposed to said ultraviolet radiation on all surfaces.

5. The apparatus of claim 1, wherein said case is contained within a larger housing having five or more sides.

6. The apparatus of claim 1, wherein said case is lined with polished aluminum sections or similar reflective material as to reflect and intensify ultraviolet radiation within said case.

7. The apparatus of claim 1, wherein said case is constructed from aluminum and through which the inside of said case is polished as to reflect and intensify ultraviolet radiation within said case.

8. The apparatus of claim 1, wherein there exists a plurality of mechanical media filters and in which each media filter is sterilized on two or more sides by a plurality of ultraviolet radiation lamps.

9. The apparatus of claim 1, wherein the powered means for the introduction of contaminated air is located outside said case.

10. The apparatus of claim 1, wherein the powered means for the exhaust of purified air is located outside said case.

11. The apparatus of claim 1, wherein said case is modular in form and design and may be quickly removed from an exterior housing and interchanged with a secondary case of like form and design.

12. The apparatus of claim 1, wherein said case is comprised of a series of tiered ultraviolet radiation lamps capable of increased or decreased intensities as required by the application.

13. An innovative apparatus for the filtration and purification of air comprising;
a self-contained interior structure designed for the purification of air comprising;
a case formed from metal;
a chamber designed to expose air and airborne contaminants to a desired intensity of ultraviolet radiation;
a means for generating ultraviolet radiation through a plurality of ultraviolet germicidal irradiation lamps;
a chamber coated internally with a chemical or compound that is naturally reactive to ultraviolet radiation.

14. The apparatus of claim 13, wherein said case is coated throughout the interior surfaces with a chemical or compound specifically designed for the production of hydroxyl radicals upon exposure to ultraviolet radiation.

15. The apparatus of claim 13, wherein said case is coated or lined throughout the interior surfaces with a singular or plurality of metal oxides in specific ratios, as would be required by the application.

16. The apparatus of claim 13, wherein said case is coated or lined throughout the interior surface with a quantity of nano-particle compounds formulated to offer maximum coverage and reaction to exposed ultraviolet radiation.
